(19) United States
(12) Patent Application Publication
(10) Pub. No.: US 2008/0071746 A1
(43) Pub. Date: Mar. 20, 2008

(54) Method For Interactive Employment Searching, Rating, And Selecting of Employment Listing

(76) Inventors: David Joseph Concordia, Worcester, MA (US); Daniel Scott DcMaioNewton, Northborough, MA (US); William M. Bradbury, Nashua, NH (US); Sundaresan Lakshminarayana, Woburn, MA (US); Gregory F. Valeri, Haverhill, MA (US)

Correspondence Address: CHADBOURNE & PARKE LLP, 30 ROCKEFELER PLAZA, NEW YORK, NY, 10112, US

(21) Appl. No.: 11/615,765

(22) Filed: Dec. 22, 2006

Related U.S. Application Data
(60) Provisional application No. 60/825,711, filed on Sep. 14, 2006.
(60) Provisional application No. 60/862,022, filed on Oct. 18, 2006.

(51) Int. Cl. G06F 17/30

(52) U.S. Cl. 707/3

(57) ABSTRACT

The present disclosure details apparatuses, systems and methods for an Interactive Employment Search Platform enabling interactive searching, rating, and selecting of employment listings. The Platform enables employers and job seekers to easily identify, connect, and coordinate with one another. The disclosed systems and methods collect profile data for job seekers and job listings. Based on this data, job seekers are presented with a selection of job listings which they are then allowed to rate. This interactive job seeker feedback tailors and refines the selection of job listings and provides a means to score the suitability of listings for a particular job seeker. At the same time, the job seeker and job listings data and ratings enable the Platform to analyze and monitor job market trends. The Platform connects job seekers with the employment opportunities most closely associated with their skills and interests, thus increasing the efficiency and effectiveness of hiring efforts.

This disclosure claims priority to U.S. Patent Application No. 60825711 entitled, “APPARATUSES, METHODS AND SYSTEMS FOR AN INTERACTIVE EMPLOYMENT SEARCH PLATFORM,” filed on Sep. 14, 2006, which is hereby incorporated by reference.

### FIELD

The present invention is generally directed to apparatuses, methods and systems for employment searching, and more particularly, to apparatuses, methods and systems for interactively searching, rating, and selecting employment listings.

### BACKGROUND

Many employment opportunities exist in the labor market and new ones become available on a daily basis. At the same time, there are many people seeking employment. Matching job seekers to suitable employment opportunities requires handling a large volume and variety of job requirements and seeker experience levels. Job seekers identify potential opportunities directly through employer listings or via passive job search engines.

### SUMMARY

This disclosure details the implementation of the apparatuses, methods, and systems for an Interactive Employment Search Platform (hereafter “Platform”) enabling interactive searching, rating, and selecting of employment listings. The Platform allows employers and job seekers to easily identify, connect, and coordinate with one another. Current methods provide only limited and passive employment search capabilities, and significant additional effort is required for job seekers to identify the opportunities best suited to them from a listing of nominal job matches. This additional effort frustrates the efficiency and efficacy of job placement efforts from both employer and job seeker perspectives. The disclosed apparatuses, methods and systems, in one embodiment, allow users to rate job listings, titles, positions, keywords, and results; it also allows for the provision of job seeker feedback regarding the suitability of employment opportunities, comprised of ratings conferred on job listings and their characterizing indices. This interactive approach facilitates the assignment of scores based on these ratings to job listings for a particular job seeker, thus matching job seekers with the opportunities for which they are most suited, improving the effectiveness of the job search process, increasing the satisfaction level of both employers and job seekers, and benefiting the labor market as a whole.

### BRIEF DESCRIPTION OF THE DRAWINGS

The accompanying appendices and/or drawings illustrate various non-limiting, representative, inventive aspects in accordance with the present disclosure:

FIG. 1 shows one embodiment of the job listing data structure;

FIG. 2 shows one embodiment of the Job Seeker profile data structure;

FIG. 3 shows one embodiment of the job listing and rating user interface;

FIG. 4 illustrates one embodiment of the job rating logic flow;

FIG. 5 illustrates one embodiment of the job title/company rating logic flow;

FIG. 6 illustrates the logic flow for one embodiment of the Interest Match score computation;

FIG. 7 illustrates the logic flow for one embodiment of the Resume Match score computation;

FIG. 8 illustrates the logic flow for one embodiment of the Skills Match score computation;

FIG. 9 illustrates the logic flow for one embodiment of the Career Spotlight score computation; and

FIG. 10 illustrates a systemization diagram for an embodiment of the Interactive Employment Search Platform.

### DETAILED DESCRIPTION

In one embodiment, the Platform employs three basic actors: (i) a Job Seeker, that is any individual or group seeking job listings or activity information using the Platform, including but not limited to people seeking employment for themselves or others, employment agencies, “headhunters”, human resources personnel, potential activity participants, and/or the like; (ii) an Employer, that is any individual or group providing job listings or activity information to the Platform, including but not limited to individuals, companies, businesses, universities, non-profit organizations, government agencies, recruiters, employment agencies, human resources personnel, activity organizers, and/or the like; and (iii) a Server capable of storing and analyzing information transmitted to and from Job Seekers and Employers. Though terms such as Job Seeker, Employer, job listing, job title, company, etc. will be utilized, they are intended to be non-limiting and should be understood to encompass all manner of activity participants, providers, information, and identifiers.

In one embodiment, the Platform acts as a conduit for connecting Job Seekers with job listings supplied by Employers. In that capacity, the Platform accepts information from Job Seekers to match them with suitable job listings. It also allows for user feedback regarding the suitability of job listings supplied by the Platform, which refines future search strategies. In another embodiment, the Platform facilitates the specification of skill sets associated with individuals, groups, organizations, job titles, job listings, companies, and/or the like and the automatic comparison of those sets.

Embodiments of the modules employed by the Platform include the following:

Job Listings 101

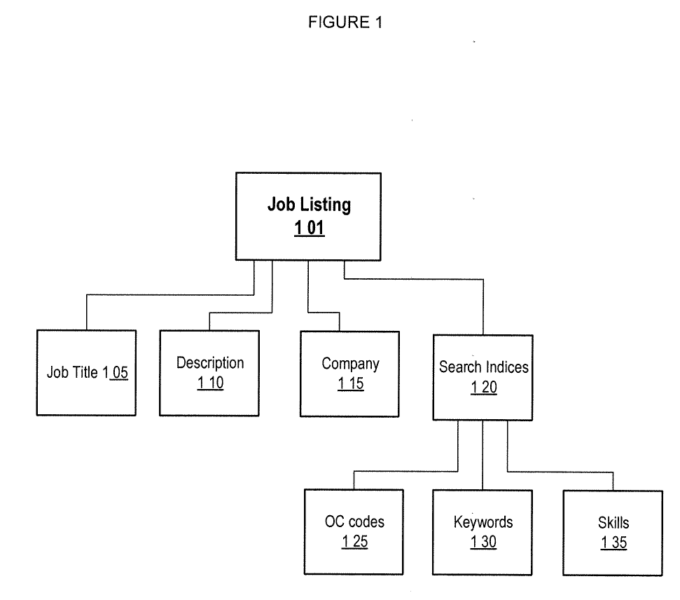

Information pertaining to available job openings is incorporated into the Platform as a job listing data structure 101, an embodiment of which is displayed in FIG. 1. Among the data that may be incorporated in this structure are a job title or set of titles 105, a description 110, and a company or set of companies 115. The description 110 may include such information as job location, requirements (e.g., education, experience, skills, etc.), responsibilities, desired qualities, salary, benefits, vacation time, contact info, and/or the like. In alternative embodiments, any or all of these data may be incorporated into the job listing data structure separately from the description. The job listing data structure may also include a plurality of search indices 120 that may be employed, for example, in selecting a particular job listing from a database of listings. Among the possible search indices envisioned within embodiments of the present invention are occupational classification (OC) codes (such as may be associated with the job listing's job title) 125, keywords 130, and skills (such as those required by the job) 135. An example of an OC code is an Occupational Information Network (ONet) Standard Occupational Classification (SOC) code. OC codes may be manually entered for a job listing by the Employer or a Platform administrator, or they may be automatically generated based on the content of the job listing. This may be accomplished, for example, by extracting the job listing job title and converting to a closely associated ONet SOC code. Keywords may be manually entered for a job listing by the Employer or a Platform administrator, or they may be automatically generated based on the content of the job listing. This may be accomplished, for example, by extracting keywords from the job listing description using an existing software-implemented keyword extraction algorithm such as Teragram Enterprise KnowledgeBase Extraction Enhancers. Skills may be manually entered for a job listing by the Employer or a Platform administrator, or they may be automatically generated based on the content of the job listing. This may be accomplished, for example, by querying a set of skills associated with an ONet SOC code automatically assigned based on the job listing job title.

In one embodiment, a job listing data structure may also include a Job Seeker ratings field, comprising a record of Job Seeker ratings related to the job listing. Such ratings, described in greater detail below, may include ratings of the job listing itself, keywords, job title, company, and/or the like. In one embodiment, analyses of the ratings may also be included in the job listing data structure. Such analyses may include statistical processing and evaluation (e.g., the calculation of means, medians, variances, standard deviations, covariances, correlations, and/or the like), graphical representations, parsing based on a variety of criteria (e.g., Job Seeker locations, experience levels, education levels, etc.), and/or the like.

In one embodiment, the XML for the job listing data structure takes the following form:

```
<job_listing>
    <job_listing_ID> 12345TechZilla </job_listing_ID>
    <job_title> Test Technician </job_title>
    <company> Techzilla </company>
    <description>
    Immediate need for Test Technicians with high voltage power supplies
    experience. Responsibilities include testing, calibrating, troubleshooting, and
    repairing new and field return power supplies to component level. Experience
    in high voltage and pulse power technology, soldering and de-soldering.
    Minimum of three years experience as an electronics technician. This position
    requires: A strong working knowledge of AC, DC, analog, and digital circuits;
    the ability to read and interpret both electronic schematics and assembly level
    drawings. MUST have In-Circuit and Functional Testing experience.
    Minimum 2 years post-secondary training in electronics (BSEE/AS degree or
    equivalent). You will perform complex test operation in absence of
    documentation. Build and test prototype assemblies. Work with limited direction.
    Troubleshoot and identify design inadequacies. Coordinate repair and schedules with
    customers. You can view all out jobs online at http://www.techzilla.com.
    </description>
    <search_indices>
        <OC_codes>
        17-3023.01 51-2022.00 51-9061.04 17-2072.00 49-2091.00
        </OC_codes>
        <keywords>
        technician, electronics, troubleshooting, circuits, power, high voltage
        </keywords>
        <skills>
        troubleshooting, repairing, equipment maintenance, equipment selection,
        time management, reading comprehension, judgment and decision making,
        operation monitoring, active learning, complex problem solving
        </skills>
    </search_indices>
</job_listing>
```

Job Seeker Profiles 201

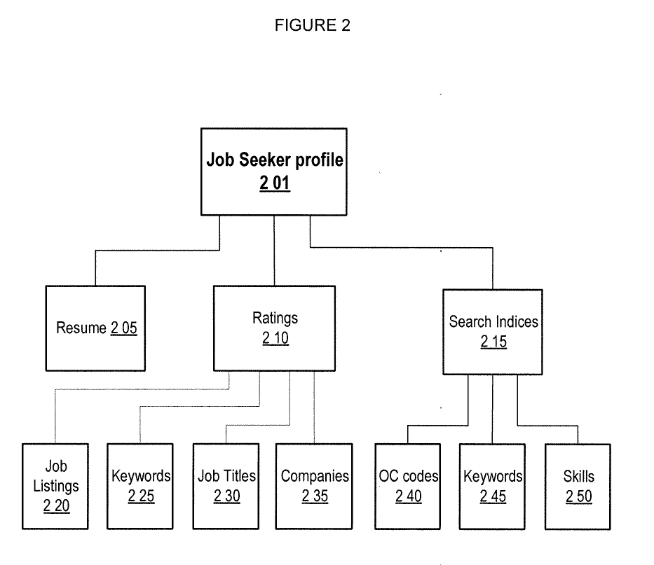

Job Seeker information is incorporated into the Platform as a Job Seeker profile data structure 201, an embodiment of which is displayed in FIG. 2. Among the data that may be included in the Job Seeker profile is the Job Seeker resume 205, which may contain a plurality of information regarding the Job Seeker such as name, address, phone number, e-mail address, website, contact information, experience, education, coursework, career goals, skills, personal statement, awards/honors, publications, professional activities, and/or the like. In one embodiment, the resume field contains a unique identifier link to a resume record. In alternative embodiments, any or all of these data may be incorporated into the Job Seeker profile separately from the resume. The Job Seeker profile may additionally include a plurality of search indices 215, with which the profile may be identified and/or selected from a database. The search indices may also be employed to compare or match a given Job Seeker profile with a plurality of job listings. Among the possible search indices envisioned within embodiments of the present invention are OC codes (such as may be associated with the Job Seeker's most recent or target job titles) 240, keywords 245, and skills (such as may be specified by the Job Seeker as being possessed by him/her) 250. The Job Seeker profile may additionally include a plurality of ratings 210 associated with job listings viewed and rated by the Job Seeker. The ratings may include job listing ratings (including a record of listings that have been rated by the Job Seeker) 220, keyword ratings 225, job title ratings 230, company ratings 235, and/or the like. In another embodiment, the Job Seeker profile ratings may also include ratings of other job characteristics and fields, such as job category, location, salary/wage, benefits, vacation time, and/or the like.

In one embodiment, the XML for the Job Seeker profile data structure takes the following form:

```
<job_seeker>
    <ID> I. M. Jobless </ID>
    <resume> MyResume.doc </resume>
    <job_ratings>
        <job_listing>
        12345Techzilla:90
        </job_listing>
        <keyword>
        technician:2, electronics:2, troubleshooting:2, circuits:2,
        power:2, high voltage:2
        </keyword>
        <job_title>
        Test_Technician:10
        </job_title>
        <company>
        Techzilla:10
        </company>
    </job_ratings>
    <search_indices>
        <OC codes>
        47-2111.00
        </OC codes>
        <keywords>
        electrician, electronics, technician
        </keywords>
        <skills>
        installation, troubleshooting, repairing, time management,
        mathematics
        </skills>
    </search_indices>
</job_seeker>
```

Rating Jobs

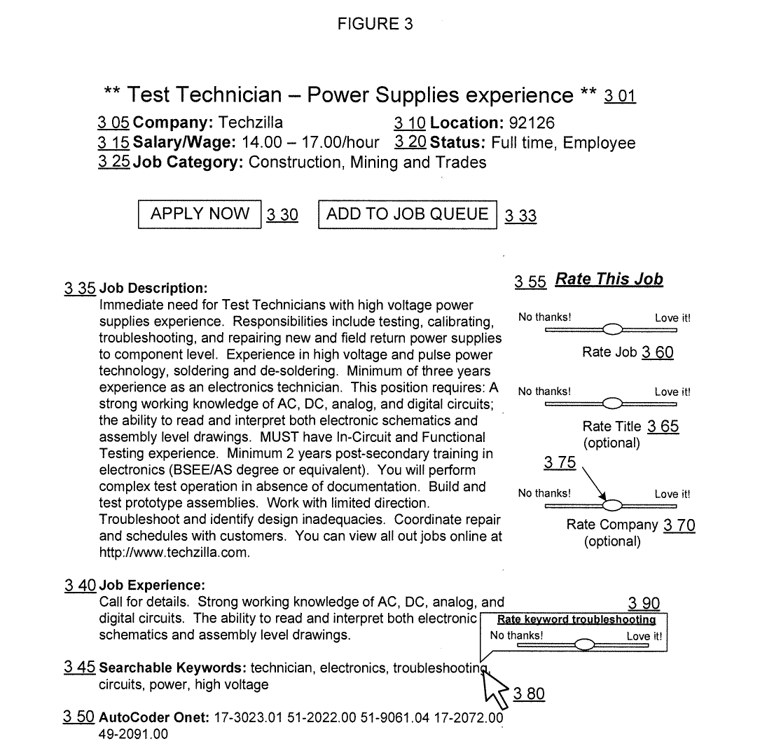

The Platform allows Job Seekers to rate job listings, which assists the Platform in tailoring and refining the future selection of job listings to present to the Job Seeker. In one embodiment, a Job Seeker rating a particular job listing indirectly assigns ratings to various fields associated with the job listing (e.g., keywords, job title, company, etc.) in addition to assigning a rating to the listing itself. FIG. 3 shows one embodiment of the job listing and rating user interface (UI). Elements of the job listing data structure 101 are displayed in the UI for the Job Seeker to review. These include the job title 301, company 305, location 310, salary/wage 315, status 320, job category 325, a job description 335, job experience requirements 340, and search indices that include searchable keywords 345 and OC codes (ONet SOC codes, in this case) 350. The UI also supplies an “Apply Now” button 330, to allow a Job Seeker to immediately apply to the listed job, and an “Add to Job Queue” button 333, which allows a Job Seeker to save a job listing in a storage area for future review. The UI further includes a rating section 355. Here, the Job Seeker is requested to rate the particular job listing itself using a “Rate Job” slider widget 360. A wide variety of other rating interfaces and mechanisms may be employed in various other embodiments of the present invention. These may include, but are not limited to, checkboxes, buttons, lists, radio buttons, scrollbars, fields, text boxes, menus, icons, and/or the like. Here, the Job Seeker is given the option to also rate the job title 365 and company 370 separately from the job listing rating. In an alternative embodiment, the slider 375, of the slider widget may be replaced by two or more sliders that would, for example, allow the Job Seeker to set a rating range by setting an upper and lower rating limit. In another embodiment, the Platform may be configured (for example, using Ajax) so that when the mouse pointer 380 is placed over a job field, such as the keyword “troubleshooting” in the figure, a slider window 390 pops up, allowing the Job Seeker to rate that job field.

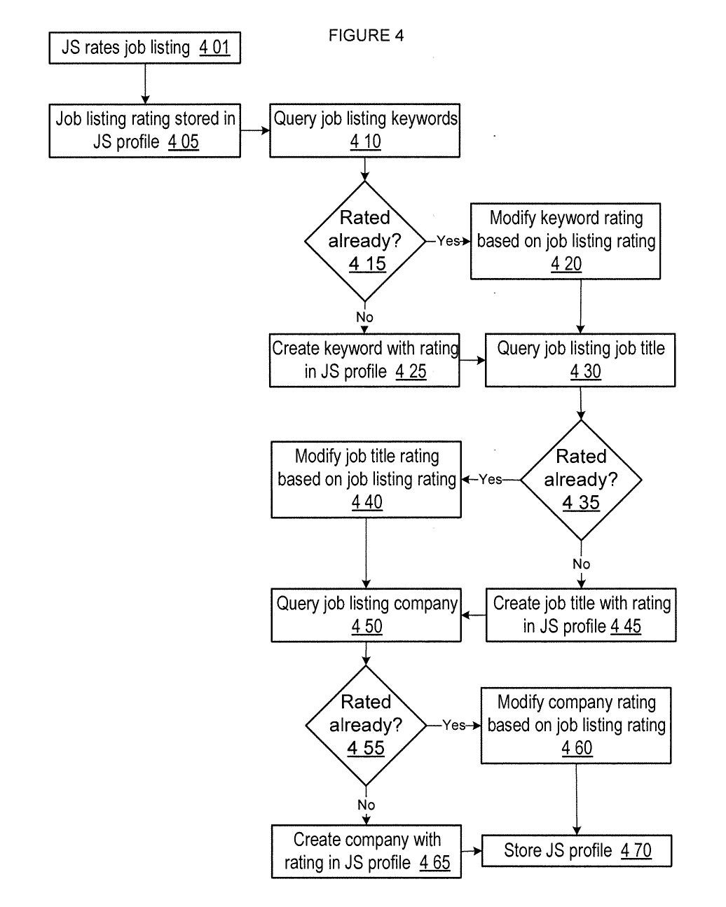

FIG. 4 illustrates one embodiment of the job rating logic flow. In this embodiment, a Job Seeker rates a job listing that he/she is viewing 401, and this listing with the associated rating is noted in the Job Seeker's profile 405. In one embodiment, a Job Seeker is only allowed to rate job listings that he/she has not rated previously, while in an alternative embodiment, the Job Seeker may re-rate job listings. When the Job Seeker rates a job listing, a set of keywords associated with that listing are queried 410 and compared to a set of rated keywords in the Job Seeker profile to determine whether or not the keywords have already been rated 415. For keywords that have been rated previously, ratings are modified based on the job listing rating 420. In one embodiment, an amount is added or subtracted to the existing keyword rating based on the job listing rating. In an alternative embodiment, the existing keyword rating is replaced with a new value based on the job listing rating. If a keyword has not been rated previously, then that keyword is appended to the set of rated keywords in the Job Seeker profile along with a rating based on the job listing rating 425. The Platform also queries a job listing job title 430. In one embodiment, multiple job titles may be associated with a given job listing and queried. The job listing job title is compared to a set of rated job titles in the Job Seeker profile to determine whether or not the job title has already been rated 435. For job titles that have been rated previously, ratings are modified based on the job listing rating 440. Again, in various embodiments, the job title rating in the Job Seeker profile may be updated or replaced based on the job listing rating. If a job title has not been rated previously, then that job title is appended to the set of rated job titles in the Job Seeker profile along with a rating based on the job listing rating 445. The Platform also queries a job listing company 450. In one embodiment, multiple companies may be associated with a given job listing and queried. The job listing company is compared to a set of rated companies in the Job Seeker profile to determine whether or not the company has already been rated 455. For companies that have been rated previously, ratings are modified based on the job listing rating 460. Again, the company rating in the Job Seeker profile may be updated or replaced in various embodiments. If a company has not been rated previously, then that company is appended to the set of rated companies in the Job Seeker profile along with a rating based on the job listing rating 465. The Job Seeker profile with updated ratings values is stored 470. In alternative embodiments, the Platform may omit rating any of the aforementioned job fields, while in still other embodiments, the Platform may include additional implicit job field ratings such as job category, location, salary/wage, benefits, vacation time, and/or the like.

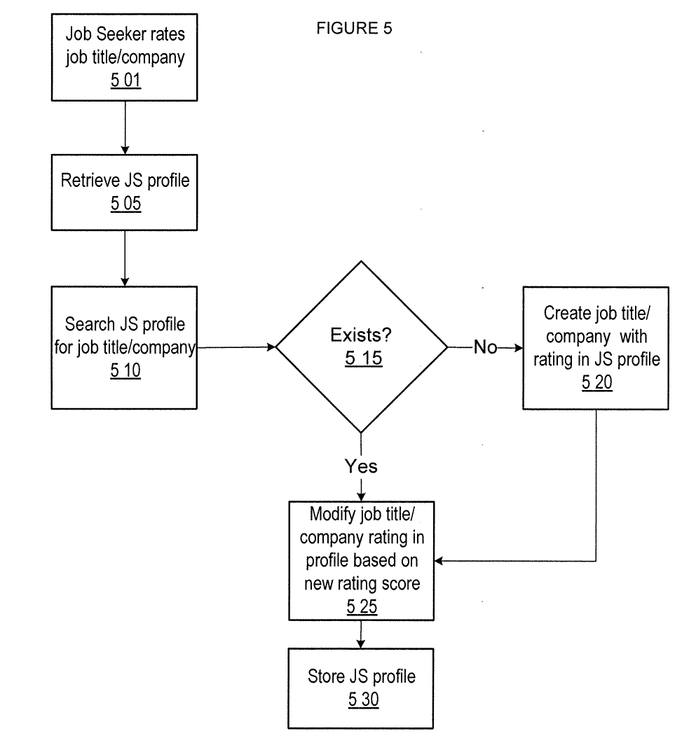

In addition to rating job listings, which indirectly assigns ratings to job listing fields such as job title and company, Job Seekers may elect in one embodiment to rate job listing fields directly. FIG. 5 illustrates one embodiment of the logic flow for direct rating of a job listing field. In this embodiment, a Job Seeker is presented with the opportunity to rate a job title and/or company associated with a particular job listing or group of listings 501. Upon rating one of these fields, the Platform retrieves the Job Seeker profile 505 and searches previously rated fields 510 to determine whether the newly rated field has been rated previously 515. If the field has not been rated previously, then that field and its rating are appended to the Job Seeker profile 520. If the field has been rated previously, then the rating in the Job Seeker profile is modified based on the new rating 525. In one embodiment, the old rating is adjusted based on the new rating, while in another embodiment, the old rating is replaced by the new rating. Finally, the modified Job Seeker profile is stored 530. In other embodiments, the Job Seeker may also directly rate other job listing fields such as keywords, job category, location, status, salary/wage, and/or the like. The interface widget or mechanism for rating may differ in general between different job listing fields.

Interest Match Score

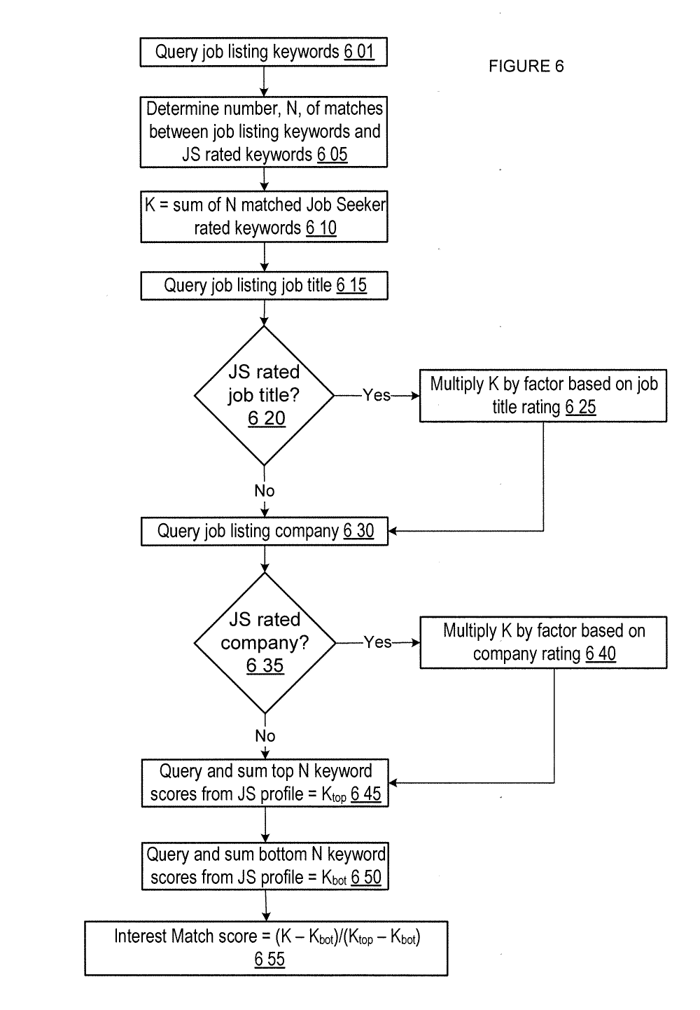

The Job Seeker ratings of job listings, job titles, company, etc. may be used to compute an Interest Match score that quantifies the congruence between a job listing and the Job Seeker. FIG. 6 illustrates the logic flow in one embodiment of the Interest Match score calculation. For a given job listing, the Platform queries the set of job listing keywords associated with that listing 601. These are compared with a set of rated keywords in the Job Seeker profile to determine a number N of elements in the intersection of the set of job listing keywords with the set of rated keywords 605. A keyword rating score is determined based on the ratings of the N elements of this intersection. In one embodiment, the ratings of the N elements are summed 610 to yield a keyword rating sum K. In an alternative embodiment, a weighted sum of keyword ratings is computed. The Platform also queries the job listing job title 615 and compares it with the set of rated job titles in the Job Seeker profile to determine whether the job title has been rated previously 620. If so, the keyword rating score is modified based on the job title rating. In one embodiment, the keyword rating sum K is multiplied by a factor to reflect the Job Seeker's rating of the job title 625. If the job title has not been rated previously, the Platform proceeds to query the job listing company 630 and compares it with the set of rated companies in the Job Seeker profile to determine whether the company has been rated previously 635. If so, the keyword rating score is modified based on the company rating. In one embodiment, the keyword rating sum K is multiplied by a factor to reflect the Job Seeker's rating of the company 640. If the company has not been rated previously, the keyword rating sum is not modified further. In alternative embodiments, the keyword rating sum may be modified based on ratings of other job listing fields such as job category, location, salary/wage, benefits, vacation time, and/or the like. The Platform queries the top rated keywords from the set of rated keywords in the Job Seeker profile and assigns a score based on their ratings. In one embodiment, N top-rated keywords are selected and their ratings are summed to yield a top-rated keyword rating sum Kₜₒₚ 645. The Platform further queries the bottom rated keywords from the set of rated keywords in the Job Seeker profile and assigns a score based on their ratings. In one embodiment, N bottom-rated keywords are selected and their ratings are summed to yield a bottom-rated keyword rating sum K_{bot} 650. The Interest Match score is calculated based on the position of the keyword rating score relative to the top-rated keyword rating score and bottom-rated keyword rating score. In one embodiment, the Interest Match score is calculated as the quotient of the difference between the keyword rating sum and the bottom-rated keyword rating sum with the difference between the top-rated keyword rating sum and the bottom-rated keyword rating sum 655. This score may be associated with and stored in the Job Seeker's profile relative to the particular job listing.

Resume Match Score

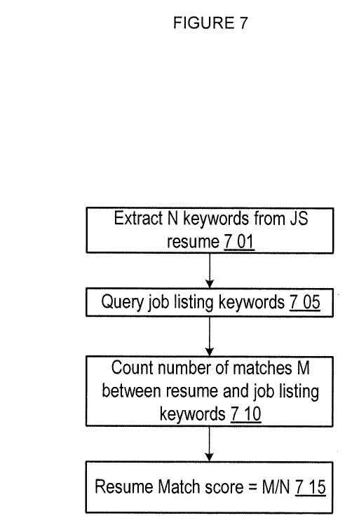

In addition to the Interest Match score assigned to a job listing based on a Job Seeker's ratings, the Platform may also calculate a Resume Match score based on the contents of the Job Seeker's resume. FIG. 7 illustrates the logic flow in one embodiment of the Resume Match score calculation. A Job Seeker submits a resume from which a set of relevant keywords are extracted and counted 701. This may be accomplished manually by a Platform administrator, or by means of an existing software-implemented keyword extraction algorithm such as Teragram Enterprise KnowledgeBase Extraction Enhancers. Keywords may be derived from any part of the resume, including the experience, education, skills, or personal statement sections, and/or the like. In one embodiment, the Job Seeker is presented with the list of resume keywords and is allowed to rate or select those keywords that they feel are most important or relevant for their job listing search. In an alternative embodiment, the Job Seeker is allowed to manually enter resume keywords to be included in the Resume Match score calculation. The Platform also queries the set of job listing keywords 705. A keyword intersection set is determined based on the intersection of the set of resume keywords and the set of job listing keywords, and the elements of the keyword intersection set are counted 710. The Resume Match score is then calculated based on the number of elements in the keyword intersection set. In one embodiment, the Resume Match score is calculated as the ratio of the number of elements in the keyword intersection set and the number of elements in the set of resume keywords 715. In an alternative embodiment, the Resume Match score incorporates any ratings that may exist in the Job Seeker profile for the keywords in the keyword intersection set or the set of resume keywords. For example, a highly rated keyword may count as more than one keyword when counting, while a low rated keyword may count as less than one keyword.

Skills Match Score

In addition to the Interest Match and Resume Match scores, the Platform may also calculate a Skills Match score based on the skill sets relevant to the Job Seeker and a particular job listing if those skill sets have been specified. A Job Seeker may specify a Job Seeker skill set by selecting skills from a list with which they are presented. For example, based on a most-recent job title, the Platform may determine a closely associated OC code with which there are an associated series of skills. These skills may be presented to the Job Seeker, who may then select those skills that he/she feels are relevant to him/her. Similarly, an Employer who posts a particular job listing may be presented with a set of skills, derived from the skill set of a closely associated occupational classification code, from which he/she may select a job listing skill set most relevant to the job listing.

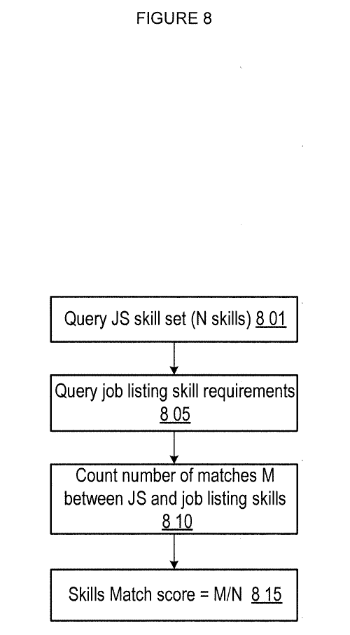

Once the Job Seeker skill set and job listing skill set are specified, a Skills Match score may be calculated. FIG. 8 illustrates the logic flow in one embodiment of the Skills Match score calculation. The Job Seeker skill set is queried, and the elements of the set are counted 801. The job listing skill set is also queried 805, and a skill intersection set is determined based on the intersection of the job listing skill set and the Job Seeker skill set. The elements of the skill intersection set are counted 810, and the Skills Match score is determined based on the number of elements in the skill intersection set. In one embodiment, the Skills Match score is calculated as the ratio of the number of elements in the skill intersection set to the number of elements in the Job Seeker skill set 815.

Career Spotlight Score

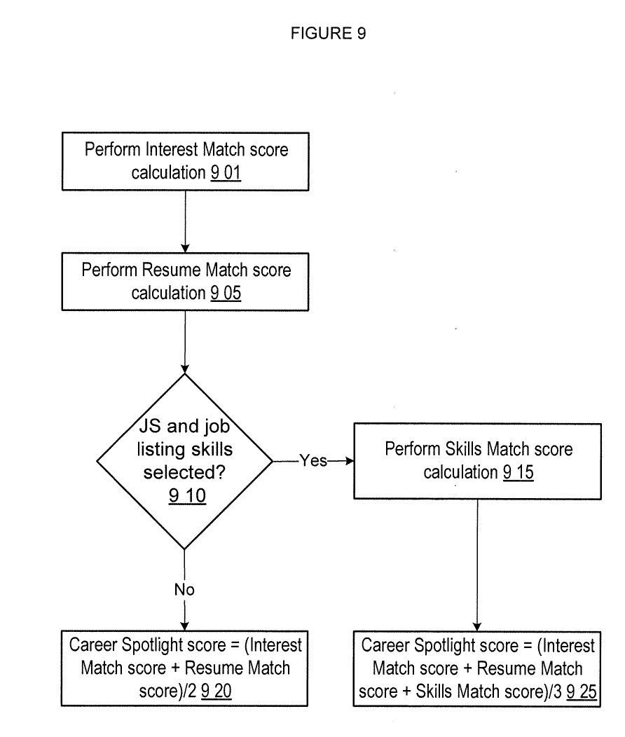

In one embodiment, a Career Spotlight score reflects the overall congruence between a job listing and a particular Job Seeker. It may be calculated based on the other scores discussed above. FIG. 9 illustrates the logic flow in one embodiment of the Career Spotlight score calculation. An Interest Match score 901 and Resume Match 905 score are calculated. The Platform determines whether the Job Seeker and job listing skill sets have been specified 910. If not, then the Career Spotlight score is calculated as the average of the Interest Match score and the Resume Match score 920. On the other hand, if the skill sets have been specified, the Skills Match score is calculated 915 and the Career Spotlight score is calculated as the average of the Interest Match score, the Resume Match score, and the Skills Match score 925. In alternative embodiments, the Career Spotlight score may be calculated as a weighted sum or average of the Interest Match score, Resume Match score, and/or Skills Match score.

Recommended Jobs

Based on the Job Seeker characteristics and ratings, the Platform may supply a set of recommended jobs that are tailored to the specific Job Seeker. In one embodiment, a number of top-rated keywords in the Job Seeker profile are queried. The Platform searches the job listings database for job listings containing these top rated keywords. The selected listings may then be ordered by the number of keywords they contain before being displayed to the Job Seeker. In another embodiment, the Job Seeker ratings for each of the rated keywords in the job listing are summed and the job listings are ordered by this keyword rating sum before being displayed to the Job Seeker. In another embodiment, the job listings are ordered by their Career Spotlight score, calculated in the manner described above, before being displayed to the user.

In another embodiment, the elements of the job listings database are searched based on their Career Spotlight score relative to the Job Seeker, and a number of top-scoring job listings are selected for display to the Job Seeker. In another embodiment, the elements of the job listings database are searched based on their Interest Match score relative to the Job Seeker, and a number of top-scoring job listings are selected for display to the Job Seeker. In another embodiment, the elements of the job listings database are searched based on their Resume Match score relative to the Job Seeker, and a number of top-scoring job listings are selected for display to the Job Seeker. In another embodiment, the elements of the job listings database are searched based on their Skills Match score relative to the Job Seeker, and a number of top-scoring job listings are selected for display to the Job Seeker.

Various Applications

The Platform provides a flexible system applicable to a wide variety of employment, educational, and skills assessment purposes. In one embodiment, the Platform supplies job listings to a Job Seeker that are targeted to the Seeker's specific experience, skills, and interest. By allowing the Job Seeker to specify personal skill levels and to provide interactive feedback through job listing ratings, the Platform is able to precisely tailor the listings supplied to the Job Seeker, thus heightening the possibility of connecting the Job Seeker to his or her ideal job listing.

In another embodiment, the Platform allows for detailed skills assessment, tracking, and profiling. Job Seekers may specify the skill levels that they possess or that they would expect their ideal jobs to require. The accumulated collection of skill specifications across Job Seekers may then be parsed and/or analyzed based on a variety of other factors associated with the Job Seeker profiles including most recent job title, target job title, experience level, education, geographic location, age, demographic criteria, and/or the like. Similarly, Employers may specify the skill levels that they expect or require for a particular job listing. The accumulated collection of job listing skill specifications may then be parsed and/or analyzed based on a variety of other factors associated with the job listings and/or Employers including job title, required experience, required education, company, geographic location, salary, vacation time, and/or the like. Therefore, in both the Job Seeker and Employer cases, the Platform may provide a detailed analysis of skills across a spectrum of criteria.

In another embodiment, the Platform allows for the assessment of job listing quality and visibility. By allowing Job Seekers to rate job listings, job titles, companies, etc., the Platform collects feedback related to job listings supplied by Employers. This feedback may not only be employed for tailoring and refining Job Seeker job listing searches, but may also be analyzed to assess, diagnose, and/or evaluate the effectiveness of the job listing itself. For example, in one embodiment, the Platform collects Job Seeker ratings for a variety of job listings having the same or similar job title and analyzes those ratings to determine which listings elicit the most positive Job Seeker response. Such analysis may form the basis for a job listing consultation service.

In an alternative embodiment, an e-mail may be sent to a Job Seeker at intervals to determine the Seeker's satisfaction with their current role and employer. The e-mail directs the user to a page for the job listing, from which they accepted their current role and may ask, in one embodiment, for evaluation. This data may be accumulated and organized over time, and presented to future Job Seekers as a job satisfaction rating.

In another embodiment, the Platform uses collected Job Seeker company ratings to assess company reputation and favorability. Job Seeker company ratings may be statistically analyzed to track opinions regarding companies, and those ratings may be parsed based on a variety of criteria (e.g., Job Seeker location, experience levels, education levels, etc.) to assess trends.

In another embodiment, the Platform tracks keyword ratings to determine which keywords are best to include in a job listing. In various embodiments, Job Seeker ratings of job listings translate to keyword ratings in the manner described above, or Job Seeker's may be allowed to rate job listing keywords directly. The Platform may then select and analyze highest rated keywords, and compare them with other job listing factors to establish keyword quality patterns. Such analysis may form the basis of a job listings consultation service.

In another embodiment, the Platform analyzes Resume Match scores to determine which keywords are most effective to include in a resume or job listing. As part of the Resume Match score calculation, keywords are extracted from resumes and job listings, and the two types of keyword sets are compared. The Platform may determine which keywords are most frequently matched and provide these for display. In one embodiment, the Platform may parse or group most frequently matched keywords based on a set of criteria (e.g., job title, experience levels, education levels, location, etc.). The determination of most highly rated keywords may form the basis for resume and/or job listing consultation services.

In another embodiment, the Platform may assess job listing effectiveness by determining which listings are applied to or added to a Job Queue most frequently and comparing that information with job listing search indices or ratings. For example, the Platform may determine which keywords, OC codes, relevant skills, job titles, companies, and/or the like are most common to job listings that are most frequently applied for or added to a Job Queue. This determination may form the basis for a job listing consultation service.

In another embodiment, the Platform allows for tracking Job Seeker trends. Each Job Seeker enters information that is stored in a respective Job Seeker profile. The collected information in a plurality of such profiles may be parsed and analyzed to establish average relationships between Job Seeker characteristics. For example, the Platform may determine correlations between Job Seeker locations and OC codes, or between experience keywords and educational levels.

In another embodiment, the Platform allows for tracking job listing trends. Each Employer enters information pertaining to a job listing that is stored in a job listing data structure. The collected information in a plurality of such data structures may be parsed and analyzed to establish average relationships between job listing characteristics. For example, the Platform may determine correlations between job listing locations and OC codes, or between job titles and skill requirements.

Platform Controller

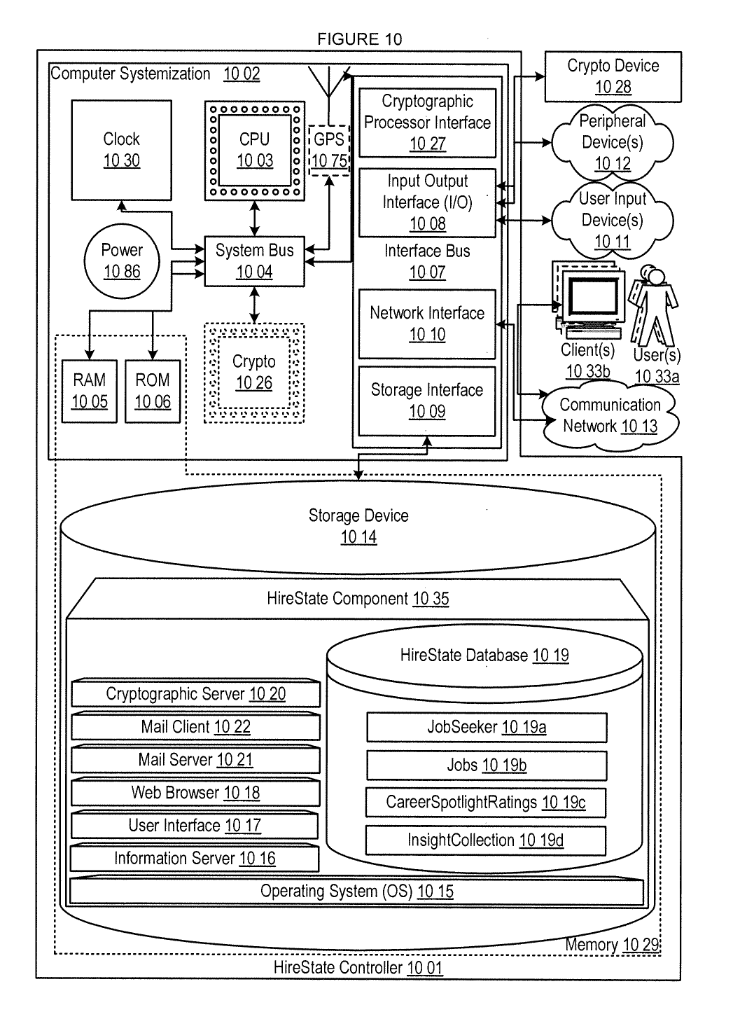

FIG. 10 of the present disclosure illustrates inventive aspects of a Platform controller 1001 in a block diagram. In this embodiment, the Platform controller 101 may serve to process, accept, retrieve, store, search, serve, submit, identify, transmit, instruct, generate, match, and/or update databases containing relevant job seeker information, employer information and/or job information, and/or related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the Platform controller 1001 may be connected to and/or communicate with entities such as, but not limited to: one or more users from user input devices 1011; peripheral devices 1012; and/or a communications network 1013.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Platform controller 1001 may be based on common computer systems that may comprise, but are not limited to, components such as: a computer systemization 1002 connected to memory 1029.

Computer Systemization

A computer systemization 1002 may comprise a clock 1030, central processing unit (CPU) 1003, a read only memory (ROM) 1006, a random access memory (RAM) 1005, and/or an interface bus 1007, and most frequently, although not necessarily, are all interconnected and/or communicating through a system bus 1004. Optionally, the computer systemization may be connected to an internal power source 1086. Optionally, a cryptographic processor 1026 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program modules for executing user and/or system-generated requests. The CPU may be a microprocessor such as AMD's Athlon, Duron and/or Opteron; IBM and/or Motorola's PowerPC; Intel's Celeron, Itanium, Pentium, Xeon, Core and/or XScale; and/or the like processor(s). The CPU interacts with memory through signal passing through conductive conduits to execute stored program code according to conventional data processing techniques. Such signal passing facilitates communication within the Platform controller and beyond through various interfaces. Should processing requirements dictate a greater amount of speed, parallel, mainframe and/or super-computer architectures may similarly be employed. Alternatively, should deployment requirements dictate greater portability, smaller Personal Digital Assistants (PDAs) may be employed.

Power Source

The power source 1086 may be of any standard form for powering small electronic circuit board devices such as the following power cells: alkaline, lithium hydride, lithium ion, nickel cadmium, solar cells, and/or the like. Other types of AC or DC power sources may be used as well. In the case of solar cells, in one embodiment, the case provides an aperture through which the solar cell may capture photonic energy. The power cell 186 is connected to at least one of the interconnected subsequent components of the Platform controller thereby providing an electric current to all subsequent components. In one example, the power source 1086 is connected to the system bus component 1004. In an alternative embodiment, an outside power source 1086 is provided through a connection across the I/O 1008 interface. For example, a USB and/or IEEE 1394 connection carries both data and power across the connection and is therefore a suitable source of power.

Interface Adapters

Interface bus(ses) 1007 may accept, connect, and/or communicate to a number of interface adapters, conventionally although not necessarily in the form of adapter cards, such as but not limited to: input output interfaces (I/O) 1008, storage interfaces 1009, network interfaces 1010, and/or the like. Optionally, cryptographic processor interfaces 1027 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1009 may accept, communicate, and/or connect to a number of storage devices such as, but not limited to: storage devices 1014, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1010 may accept, communicate, and/or connect to a communications network 1013. Through a communications network 1013, the Platform controller is accessible through remote clients 1033b (e.g., computers with web browsers) by users 1033a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1010 may be used to engage with various communications network types 1013. For example, multiple network interfaces may be employed to allow for the communication over broadcast, multicast, and/or unicast networks.

Input Output interfaces (I/O) 1008 may accept, communicate, and/or connect to user input devices 1011, peripheral devices 1012, cryptographic processor devices 1028, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 1011 may be card readers, dongles, finger print readers, gloves, graphics tablets, joysticks, keyboards, mouse (mice), remote controls, retina readers, trackballs, trackpads, and/or the like.

Peripheral devices 1012 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the Platform controller may be embodied as an embedded, dedicated, and/or monitor-less (i.e., headless) device, wherein access would be provided over a network interface connection.

Memory

Generally, any mechanization and/or embodiment allowing a processor to affect the storage and/or retrieval of information is regarded as memory 1029. However, memory is a fungible technology and resource, thus, any number of memory embodiments may be employed in lieu of or in concert with one another. It is to be understood that the Platform controller and/or a computer systemization may employ various forms of memory 1029. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1029 will include ROM 1006, RAM 1005, and a storage device 1014. A storage device 1014 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); and/or other devices of the like. Thus, a computer systemization generally requires and makes use of memory.

Module Collection

The memory 1029 may contain a collection of program and/or database modules and/or data such as, but not limited to: operating system module(s) 1015 (operating system); information server module(s) 1016 (information server); user interface module(s) 1017 (user interface); Web browser module(s) 1018 (Web browser); database(s) 1019; cryptographic server module(s) 1020 (cryptographic server); the Platform module(s) 1035; and/or the like (i.e., collectively a module collection). These modules may be stored and accessed from the storage devices and/or from storage devices accessible through an interface bus. Although non-conventional software modules such as those in the module collection, typically, are stored in a local storage device 1014, they may also be loaded and/or stored in memory such as: peripheral devices, RAM, remote storage facilities through a communications network, ROM, various forms of memory, and/or the like.

Operating System

The operating system module 1015 is executable program code facilitating the operation of the Platform controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Palm OS, Windows 2000/2003/3.1/95/98/CE/Millenium/NT/XP (Server), and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the Platform controller to communicate with other entities through a communications network 1013. Various communication protocols may be used by the Platform controller as a subcarrier transport mechanism for interaction, such as, but not limited to: multicast, TCP/IP, UDP, unicast, and/or the like.

Information Server

An information server module 1016 is stored program code that is executed by the CPU. The information server may be a conventional Internet information server such as, but not limited to Apache Software Foundation's Apache, Microsoft's Internet Information Server, and/or the. The information server may allow for the execution of program modules through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on the Platform controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other modules in a module collection, including itself, and/or facilities of the like. Most frequently, the information server communicates with the Platform controller, operating systems, other program modules, user interfaces, Web browsers, and/or the like.

Also, an information server may contain, communicate, generate, obtain, and/or provide program module, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface module 1017 is stored program code that is executed by the CPU. The user interface may be a conventional graphic user interface as provided by, with, and/or a top operating systems and/or operating environments such as Apple Macintosh OS, e.g., Aqua, Microsoft Windows (NT/XP), Unix X Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses.

Web Browser

A Web browser module 1018 is stored program code that is executed by the CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScript, ActiveX, and/or the like. Web browsers and like information access tools may be integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Platform enabled nodes. The combined application may be nugatory on systems employing standard Web browsers.

The Platform Database

The Platform database 1019 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Platform database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the Platform database is implemented as a data-structure, the use of the Platform database 1019 may be integrated into another component such as the Platform controller module 1035. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1019 includes several tables 119a-d. A JobSeeker table 1019a includes fields such as, but not limited to: job seeker name, job seeker ID number, address, education, skills, work experience, stored resume, and/or the like. A Jobs table 1019b includes fields such as, but not limited to: job title, company, category, description, keywords, and/or the like. A CareerSpotlightRatings table 1019c includes fields such as, but not limited to: job ID, job ratings, job title ratings, company ratings, job category ratings, and/or the like. An InsightCollection table 1019d includes fields such as, but not limited to: labor market and workforce development data, history, locations, keywords, categories, and/or the like. These and/or other tables may support and/or track multiple entity accounts on the Platform.

In one embodiment, the Platform database may interact with other database systems. For example, employing a distributed database system, queries and data access by Platform modules may treat the combination of the Platform database and integrated data security layer database as a single database entity.

In one embodiment, user programs may contain various user interface primitives, which may serve to update the Platform. Also, various accounts may require custom database tables depending upon the environments and the types of entities the Platform may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1019a-d. The Platform may be configured to keep track of various settings, inputs, and parameters via database controllers.

The Platform database may communicate to and/or with other components in a component collection, including itself, and/or facilities of the like. Most frequently, the Platform database communicates with the Platform controller module, other program components, and/or the like. The database may contain, retain, and provide information regarding other nodes and data.

Platform Controller Module

The Platform controller module 1035 is stored program code that is executed by the CPU. The Platform controller module affects accessing, obtaining and the provision of a Platform, and/or the like across various communications networks. The Platform enables Job Seekers and Employers to easily identify, connect, and coordinate with one another.

The Platform controller module enabling access of information between nodes may be developed by employing standard development tools such as, but not limited to: (ANSI) (Objective-) C (++), Apache modules, binary executables, database adapters, Java, JavaScript, mapping tools, procedural and object oriented development tools, PERL, Python, shell scripts, SQL commands, web application server extensions, WebObjects, and/or the like. The Platform controller module may communicate to and/or with other modules in a module collection, including itself, and/or facilities of the like. Most frequently, the Platform controller module communicates with the Platform library, operating systems, other program modules, and/or the like. The Platform controller module may contain, communicate, generate, obtain, and/or provide program module, system, user, and/or data communications, requests, and/or responses.

Distributed Platform

The structure and/or operation of any of the Platform controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The configuration of the Platform controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A method of connecting Job Seekers and job listings, comprising:
displaying job characteristics as part of a job listing;
displaying a rating mechanism for the job characteristics;
receiving a rating for a job characteristic when an associated rating mechanism is engaged;
querying a job database based on the job characteristic rating; and
returning job listings based on the query.

2. The method of claim 1, further comprising:
assigning weights to the job characteristic based on the associated rating.

3. A method of connecting Job Seekers and job listings, comprising:
receiving a Job Seeker resume;
extracting a plurality of resume keywords from the Job Seeker resume;
querying a set of job listing keywords;
determining a keyword intersection set based on the intersection of the set of resume keywords and the set of job listing keywords; and
calculating a resume match score based on the keyword intersection set.

4. The method of claim 3, wherein the resume match score is calculated as a quotient of the number of elements in the keyword intersection set and the number of elements of the set of resume keywords.

5. A method for rating job listings, comprising:
presenting a job listing for display;
receiving a job listing rating;
storing the job listing rating in a Job Seeker profile;
querying a set of job listing keywords;
querying a set of rated keywords from the Job Seeker profile;
comparing the job listing keywords with the Job Seeker profile rated keywords;
modifying the keyword ratings in the Job Seeker profile for job listing keywords that appear in the set of Job Seeker profile rated keywords based on the job listing rating;
appending the remaining job listing keywords and keyword ratings assigned based on the job listing rating to the set of Job Seeker profile rated keywords; and
storing the Job Seeker profile.

6. The method of claim 5, further comprising:
querying a set of job listing job titles;
querying a set of rated job titles from the Job Seeker profile;
comparing the job listing job titles with the Job Seeker profile rated job titles;
modifying the job title ratings in the Job Seeker profile for job listing job titles that appear in the set of Job Seeker profile rated job titles based on the job listing rating; and
appending the remaining job listing job titles that don't appear in the set of Job Seeker profile rated job titles, and ratings for the remaining job listing job titles based on the job listing rating, to the set of Job Seeker profile rated job titles.

7. The method of claim 6, further comprising:
querying a set of job listing companies;
querying a set of rated companies from the Job Seeker profile;
comparing the job listing companies with the Job Seeker profile rated companies;
modifying the company ratings in the Job Seeker profile for job listing companies that appear in the set of Job Seeker profile rated companies based on the job listing rating; and
appending the remaining job listing companies that don't appear in the set of Job Seeker profile rated companies, and ratings for the remaining job listing job companies based on the job listing rating, to the set of Job Seeker profile rated companies.

8. The method of claim 5, further comprising:
querying a set of job listing companies;
querying a set of rated companies from the Job Seeker profile;
comparing the job listing companies with the Job Seeker profile rated companies;
modifying the company ratings in the Job Seeker profile for job listing companies that appear in the set of Job Seeker profile rated companies based on the job listing rating; and
appending the remaining job listing companies that don't appear in the set of Job Seeker profile rated companies, and ratings for the remaining job listing job companies based on the job listing rating, to the set of Job Seeker profile rated companies.

9. A method of connecting Job Seekers and job listings, comprising:
querying a set of job listing keywords;
querying a set of Job Seeker rated keywords from a Job Seeker profile;
determining a number N of matches between the set of job listing keywords and the set of Job Seeker rated keywords;
determining a sum S of rating scores for the N matched Job Seeker rated keywords;
querying a job listing job title;
determining if the job title exists in a set of Job Seeker rated job titles in the Job Seeker profile;
multiplying S by a factor if the job title exists in the set of Job Seeker rated job titles;
querying a job listing company;
determining if the company exists in a set of Job Seeker rated companies in the Job Seeker profile;
multiplying S by a factor if the company exists in the set of Job Seeker rated companies;
querying a top N rated keywords from the set of Job Seeker rated keywords;
determining a sum S′ of rating scores for the top N rated keywords;
querying a bottom N rated keywords from the set of Job Seeker rated keywords;
determining a sum S″ of rating scores for the bottom N rated keywords; and
calculating an interest match score given by the quotient of the S-S″ and S′-S″.

10. A method for connecting Job Seekers and job listings, comprising:
querying a set of job listing keywords;
querying a set of Job Seeker rated keywords;
determining a keyword intersection set comprised of the intersection of the set of job listing keywords and the set of Job Seeker rated keywords;
calculating a keyword rating score based on the keyword intersection set;
selecting a plurality of top rated keywords from the set of Job Seeker rated keywords;
calculating a top rated keyword rating score based on the plurality of top rated keywords;
selecting a plurality of bottom rated keywords from the set of Job Seeker rated keywords;
calculating a bottom rated keyword rating score based on the plurality of bottom rated keywords; and
calculating an overall job listing score based on the keyword rating score, the top rated keyword rating score, and the bottom rated keyword rating score.

11. The method of claim 10, further comprising:
querying a set of job listing job titles;
querying a set of Job Seeker rated job titles;
determining a job title intersection set comprised of the intersection of the set of job listing job titles and the set of Job Seeker rated job titles; and
modifying the keyword rating score based on a Job Seeker rating of each element of the job title intersection set.

12. The method of claim 10, further comprising:
querying a set of job listing companies;
querying a set of Job Seeker rated companies;
determining a company intersection set comprised of the intersection of the set of job listing companies and the set of Job Seeker rated companies; and
modifying the keyword rating score based on a Job Seeker rating of each element of the company intersection set.

13. The method of claim 10, wherein the keyword rating score is calculated as the sum of Job Seeker ratings for the elements of the keyword intersection set.

14. The method of claim 13, wherein the top rated keyword rating score is calculated as the sum of Job Seeker ratings for the elements of the top rated keyword intersection set.

15. The method of claim 14, wherein the bottom rated keyword rating score is calculated as the sum of Job Seeker ratings for the elements of the bottom rated keyword intersection set.

16. The method of claim 15, wherein the overall job listing rating score is calculated as the percentage of the difference between the top rated keyword rating score and the bottom rated keyword rating score made up by the difference between the keyword rating score and the bottom rated keyword rating score.

17. The method of claim 10, wherein the plurality of top rated keywords and the plurality of bottom rated keywords each have as many elements as the keyword intersection set.

18. A job listing data structure, embodied in an electronic storage medium, comprising:
a job title;
a job description;
a company name; and
a plurality of search indices, comprising:
occupational classification codes;
keywords; and
relevant skills;

19. The data structure of claim 18, further comprising:
a Job Seeker ratings field.

20. A Job Seeker profile data structure, embodied in an electronic storage medium, comprising:
a Job Seeker resume; and
a Job Seeker ratings collection, comprising:
a list of rated job listings;
keyword ratings;
job title ratings; and
company ratings.

21. The data structure of claim 20, further comprising:
a plurality of search indices.

22. The data structure of claim 21, wherein the plurality of search indices includes occupational classification codes.

23. The data structure of claim 22, wherein the plurality of search indices includes keywords.

24. The data structure of claim 21, wherein the plurality of search indices includes relevant skills.
